(19) United States
(12) Patent Application Publication
(10) Pub. No.: US 2024/0157428 A1
(43) Pub. Date: May 16, 2024

(54) HEMMING SYSTEM AND HEMMING METHOD

(71) Applicants: Satoshi TSUDA, Toyota-shi (JP); Akito TOJO, Toyota-shi (JP); Hiroshi TENDA, Toyota-shi (JP); Masashi YAMAMOTO, Nagoya-shi (JP); Ichigen SUZUKI, Nagoya-shi (JP)

(72) Inventors: Satoshi TSUDA, Toyota-shi (JP); Akito TOJO, Toyota-shi (JP); Hiroshi TENDA, Toyota-shi (JP); Masashi YAMAMOTO, Nagoya-shi (JP); Ichigen SUZUKI, Nagoya-shi (JP)

(73) Assignees: TOYOTA JIDOSHA KABUSHIKI KAISHA, Toyota-shi (JP); TAKATSU MFG. CO., LTD., Nagoya-shi (JP)

(21) Appl. No.: 18/486,575

(22) Filed: Oct. 13, 2023

(30) Foreign Application Priority Data
Nov. 15, 2022 (JP) 2022-182630

(51) Int. Cl. B21D 39/02; B25J 11/00

(52) U.S. Cl. CPC B21D 39/021; B25J 11/005

(57) ABSTRACT

A hemming system includes a processing station; a processing robot for performing hemming on a workpiece in the processing station; a die storage for storing dies for hemming in association with types of workpiece; a first-stage changing station in which a die used by the processing robot when performing hemming on a next different type of workpiece and corresponds to the next different type of workpiece is disposed on standby; first transfer means for transferring the die in the first-stage changing station to the processing station; a second-stage changing station in which the die disposed in the processing station is temporarily disposed; second transfer means for transferring the die disposed in the processing station to the second-stage changing station; and a mobile robot for moving the die from the second-stage changing station to the die storage and move the die from the die storage to the first-stage changing station.

### CROSS REFERENCE TO RELATED APPLICATIONS

This application is based upon and claims the benefit of priority from Japanese patent application No. 2022-182630, filed on Nov. 15, 2022, the disclosure of which is incorporated herein in its entirety by reference.

### BACKGROUND

The present disclosure relates to a hemming system for performing hemming on a workpiece, and a hemming method.

A hemming system in which a die used in a processing station in which hemming is performed on a workpiece is changed according to the type of the workpiece has been known (see, for example, International Patent Publication No. WO2012/039320).

### SUMMARY

In the above-described hemming system, when the die in the processing station is to be changed, a die replacement robot takes out the die from the processing station, moves the die to a die storage, and disposes it in the die storage. Then, the die replacement robot takes out the next die from the die storage, moves the die to the processing station, and disposes it in the processing station. Since it takes time to replace the die in the processing station as described above, it is desired that the cycle time be shortened.

The present disclosure has been made to solve the above-described problem, and an object thereof is to provide a hemming system and a hemming method capable of shortening a cycle time.

In an aspect of the present disclosure to achieve the above-described object, a hemming system includes:
a processing station;
a processing robot disposed around the processing station and configured to perform hemming on a workpiece disposed in the processing station;
a die storage configured to store each of dies in association with a respective type of workpiece, the dies being configured to be used when the hemming is performed;
a first-stage changing station in which a die that will be used by the processing robot when the processing robot performs hemming on a next different type of workpiece and hence corresponds to the next different type of workpiece is disposed on standby; first transfer means for transferring the die disposed in the first-stage changing station to the processing station;
a second-stage changing station in which the die disposed in the processing station is temporarily disposed; second transfer means for transferring the die disposed in the processing station to the second-stage changing station; and
a mobile robot configured to move the die from the second-stage changing station to the die storage and move the die from the die storage to the first-stage changing station.

In an aspect, the first transfer means may be a first LM guide including a linear guide mechanism configured to guide a die disposed in the first-stage changing station toward the processing station in a straight line, and an actuator configured to drive the linear guide mechanism, and
the second transfer means may be a second LM guide including a linear guide mechanism configured to guide a die disposed in the processing station toward the second changing station in a straight line, and an actuator configured to drive the linear guide mechanism.

In an aspect, the hemming system may further include a control unit configured to control the processing robot, the first and second transfer means, and the mobile robot, in which
when the hemming in a current cycle is completed, the control unit may transfer and temporarily dispose a die, which has been used in the hemming in the current cycle, from the processing station to the second-stage changing station by controlling the second transfer means, and at the same time, transfer a die, which has been disposed on standby in the first-stage changing station and will be used in hemming in a next cycle, to the processing station by controlling the first transfer means.

In an aspect, a plurality of the processing robots, the first-stage changing station, and the second-stage changing station may be arranged around the processing station in a circumferential configuration,
the first and second-stage changing stations may be arranged so that they are opposed to each other with the processing robot interposed therebetween,
the first transfer means may radially extend, between the processing robots, from the processing station located at the center of the circumference to the first-stage changing station, and
the second transfer means may radially extend, between the processing robots, from the processing station located at the center of the circumference to the second-stage changing station.

In an aspect, the mobile robot may be disposed adjacent to the first and second-stage changing stations, and the die storage in such a manner that the mobile robot is interposed between the first and second-stage changing stations and the die storage.

In an aspect, the hemming system may further include:
a carrying-in apparatus configured to carry in the workpiece to the processing station;
a carrying-out apparatus configured to carry out the workpiece from the processing station.

In another aspect of the present disclosure to achieve the above-described object, a hemming method includes:
performing, by a processing robot disposed around a processing station, hemming on a workpiece disposed in the processing station;
transferring, by first transfer means, a die disposed in a first-stage changing station to the processing station, the first-stage changing station being configured so that a die corresponding to a next type of workpiece is disposed on standby therein, the die being one that the processing robot will use when it performs hemming on the next type of workpiece;
transferring, by second transfer means, the die disposed in the processing station to a second-stage changing station in which the die disposed in the processing station is temporarily disposed; and
moving, by a mobile robot, the die disposed in the second-stage changing station to a die storage and move a die stored in the die storage to the first-stage changing station.

According to the present disclosure, it is possible to provide a hemming system and a hemming method capable of shortening a cycle time.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 shows a schematic configuration of a hemming system according to an embodiment;

FIG. 2 is a block diagram showing a schematic system configuration of the hemming system according to the embodiment;

FIG. 3 is a side view of first and third processing robots and a processing station;

FIG. 4 is a top view of first and second LM guides as viewed from above;

FIG. 5 is a flowchart showing a flow of a hemming method according to an embodiment; and

FIG. 6 shows a schematic configuration of a hemming system according to an embodiment.

### DESCRIPTION OF EMBODIMENTS

### First Embodiment

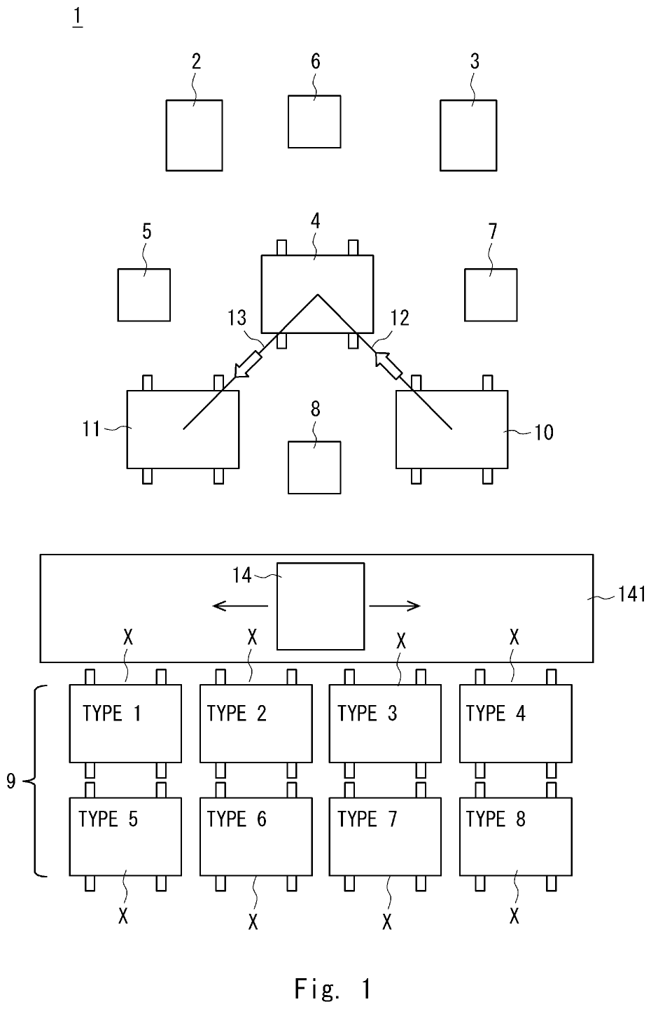

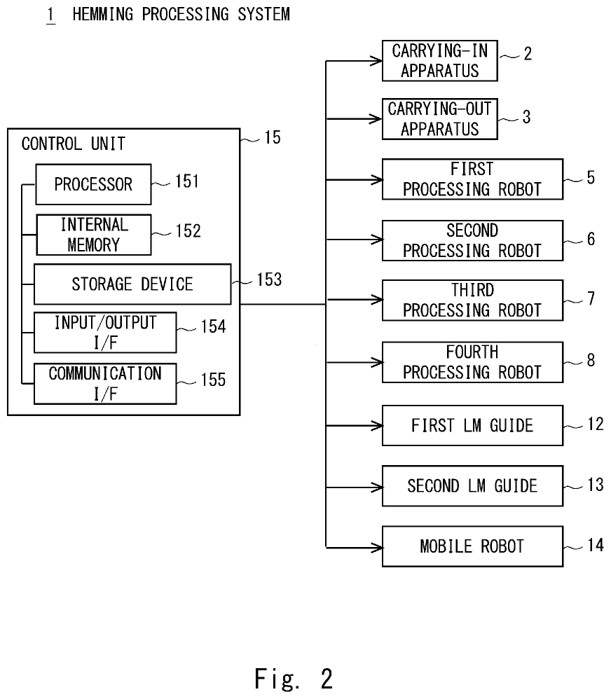

An embodiment according to the present disclosure will be described hereinafter with reference to the drawings. FIG. 1 shows a schematic configuration of a hemming system according to this embodiment. FIG. 2 is a block diagram showing a schematic system configuration of the hemming system according to this embodiment.

A hemming system 1 according to this embodiment includes a carrying-in apparatus 2, a carrying-out apparatus 3, a processing station 4, first to fourth processing robots 5, 6, 7 and 8, a die storage 9, a first-stage changing station 10, a second-stage changing station 11, a first LM guide 12, a second LM guide 13, a mobile robot 14, and a control unit 15.

The carrying-in apparatus 2 carries in a workpiece to the processing station 4 in response to a control signal from the control unit 15. The carrying-in apparatus 2 is disposed adjacent to the processing station 4. The carrying-in apparatus 2 is configured, for example, as a conveyance robot such as an AGV (Automatic Guided Vehicle). The carrying-in apparatus 2 carries in a workpiece, on which hemming will now be performed, to the processing station 4 and disposes the workpiece therein.

The carrying-out apparatus 3 carries out a workpiece from the processing station 4 in response to a control signal from the control unit 15. The carrying-out apparatus 3 is disposed adjacent to the processing station 4. The carrying-out apparatus 3 is configured, for example, as a conveyance robot such as an AGV (Automatic Guided Vehicle). The carrying-out apparatus 3 takes out a workpiece for which hemming has been completed from the processing station 4 and carries out the workpiece therefrom.

The processing station 4 is formed by, for example, a turntable. A workpiece for which hemming is to be performed is disposed in the processing station 4. The workpiece is, for example, a panel for a vehicle (hereinafter also referred to as a vehicle panel), such as a front door panel, a rear door panel, or a hood panel of a vehicle.

Note that in the hemming, a large processing force is applied to the workpiece in order to, for example, bend a flange of the workpiece. Therefore, in the hemming, a die (lower die) X using a high-strength casting or the like capable of tolerating such a processing force applied to a workpiece is used.

The die X, which is used when hemming is performed on the workpiece, is positioned in and fixed to the processing station 4 by a receiving jig or the like interposed therebetween. The die X is a dedicated die for its respective workpiece.

Hemming (which will be described later) is performed in a state in which the workpiece is positioned on and fixed to the die X by a positioning mechanism for positioning the workpiece on the die.

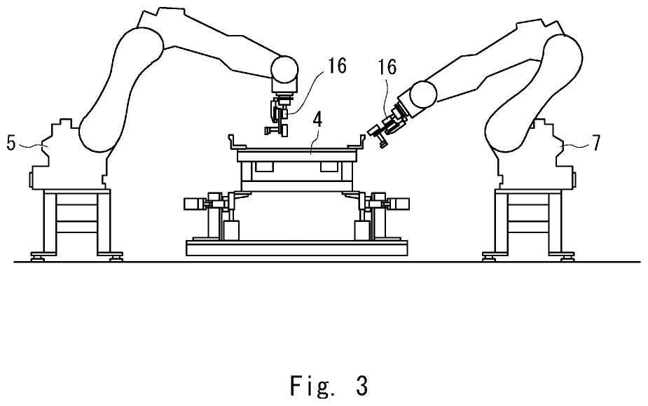

FIG. 3 is a side view of the first and third processing robots and the processing station. The first to fourth processing robots 5, 6, 7 and 8 are arranged around the processing station 4. The first to fourth processing robots are arranged around the processing station 4 in such a manner that they surround the processing station 4.

The first and third processing robots 5 and 7 are arranged so as to be opposed to each other with the processing station 4 interposed therebetween. The second and fourth processing robots 6 and 8 are arranged so as to be opposed to each other with the processing station 4 interposed therebetween.

Note that the above-described arrangement of processing robots is merely an example and the arrangement is not limited to this example. The number and positions of processing robots may be arbitrarily determined as long as they are arranged around the processing station 4.

For example, in the case of a configuration in which the fourth processing robot 8 is not used and the processing station 4 is surrounded only by the first to third processing robot 5, 6 and 7, the first-stage and second-stage changing stations 10 and 11 are disposed adjacent to each other. In this way, the moving distance of the first and second LM guides 12 and 13 can be shortened.

Each of the first to fourth processing robots 5, 6, 7 and 8 is configured, for example, as an articulated arm robot. The first to fourth processing robots 5, 6, 7 and 8 perform so-called roller hemming on a workpiece disposed on a die X disposed in the processing station 4 in response to a control signal from the control unit 15. A roller-like hemming tool 16 is attached to the tip (i.e., the end) of the arm of each of the first to fourth processing robots 5, 6, 7 and 8.

As the hemming tool 16, for example, a plurality of rotatable hemming rollers having different diameters are provided on the same axis. The first to fourth processing robots 5, 6, 7 and 8 may perform roller hemming by selectively using the hemming rollers.

For example, the first to fourth processing robots 5, 6, 7 and 8 perform roller hemming, by using the hemming rollers of the hemming tools 16, by bending flange parts of the workpiece and joining the flange parts together. The first to fourth processing robots 5, 6, 7 and 8 perform the above-described hemming in a cooperative manner.

The die storage 9 stores each of a plurality of dies X, which are used when the above-described hemming is performed, in association with a respective type of workpiece. For example, vehicle panels have different shapes according to the type of vehicle. Therefore, in the die storage 9, a plurality of types of dies X are disposed (i.e., stored) in association with the aforementioned plurality of types of vehicle panels. In this way, it is possible to perform hemming in a flexible manner according to, among a plurality of different types of vehicle panels, the type of the vehicle panel to be processed.

The die storage 9 is disposed adjacent to the mobile robot 14. The die storage 9 is configured, for example, as a frame-like rack. In this rack, the die storage 9 stores, for example, eight types of dies X (Type 1 to Type 8) in two rows in a horizontal position. In this embodiment, by using these eight types of dies X while replacing them with one another, it is possible to perform hemming on eight types of workpieces by using only one hemming system.

Note that the number of dies X housed in the above-described die storage 9 is merely an example and the number is not limited to this example. For example, seven or fewer, or nine or more types of dies X may be housed in the die storage 9.

As described above, even when the type of vehicle panel is changed, hemming can be performed in a flexible manner according to the change.

In the first-stage changing station 10, a die X that will be used by the first to fourth processing robots 5, 6, 7 and 8 when they perform hemming on the next type of workpiece and hence corresponds to the next type of workpiece is disposed.

That is, the first-stage changing station 10 serves as a temporary place where the die X that will be used for the next type of workpiece in the processing station 4 is temporarily disposed on standby. The next die X can be quickly disposed in the processing station 4 without requiring a waiting time by using the above-described first-stage changing station 10, so that the next hemming can be quickly performed.

The first-stage changing station 10 is formed by, for example, a table. The first-stage changing station 10 is disposed between the mobile robot 14 and the processing station 4.

In the second-stage changing station 11, a die X which the first to fourth processing robots 5, 6, 7 and 8 have finished using in the hemming for the current type of workpiece in the processing station 4 is disposed. That is, the second-stage changing station 11 serves as a temporary place where the die X that has been used for the current type of workpiece in the processing station 4 is quickly and temporarily disposed. It is possible, by using the above-described second-stage changing station 11, to quickly and temporarily dispose (i.e., temporarily remove) the die X, the use of which has been finished and which is disposed in the processing station 4, and to dispose the next die in the processing station 4 at the same time.

The second-stage changing station 11 is formed by, for example, a table. The second-stage changing station 11 is disposed between the mobile robot 14 and the processing station 4. The first-stage and second-stage changing stations 10 and 11 are arranged so as to be opposed to each other with the fourth processing robot 8 interposed therebetween.

The first LM guide 12 is a specific example of the first transfer means. The first LM guide 12 is disposed between the first-stage changing station 10 and the processing station 4. The first LM guide 12 connects the first-stage changing station 10 with the processing station 4.

The first LM guide 12 transfers a die X disposed in the first-stage changing station 10 to the processing station 4 in response to a control signal from the control unit 15. The first LM guide 12 disposes the die X in the processing station 4. Note that the processing station 4 is configured so that the die X is positioned in and fixed to the processing station 4 at the position where the die X has been moved to, i.e., the position at the end of the first LM guide 12 on the processing station 4 side.

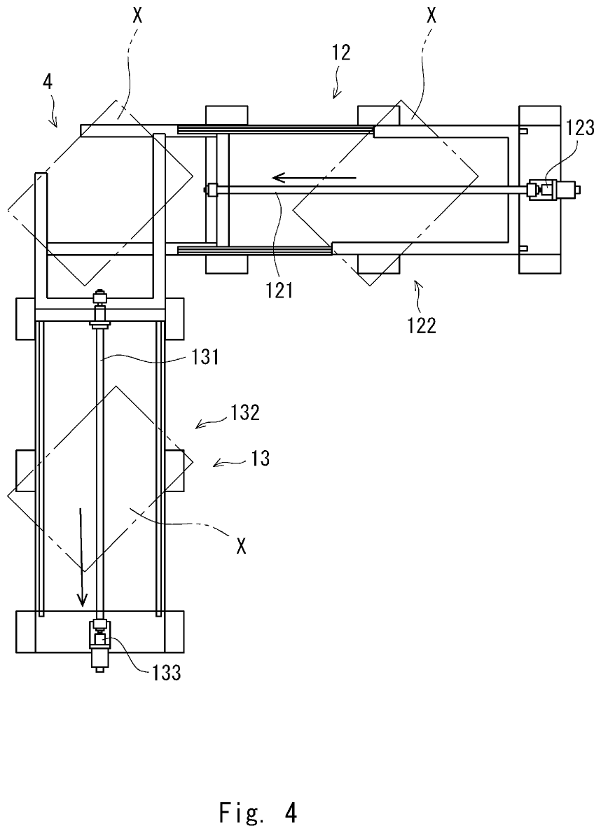

FIG. 4 is a top view of the first and second LM guides as viewed from above. The first LM guide 12 includes a linear guide mechanism 122 for guiding a die X disposed in the first-stage changing station 10 toward the processing station 4 in a straight line by using a ball screw 121 or the like, and an actuator 123, such as a servomotor, that drives the linear guide mechanism 122.

The control unit 15 can transfer, by controlling the first LM guide 12, a die X disposed on standby in the first-stage changing station 10 to the processing station 4 at a high speed, and accurately place the die X at a predetermined position in the processing station 4.

The second LM guide 13 is a specific example of the second transfer means. As shown in FIG. 1, the second LM guide 13 is disposed between the second-stage changing station 11 and the processing station 4. The second LM guide 13 connects the second-stage changing station 11 with the processing station 4. The second LM guide 13 transfers the die X disposed in the processing station 4 to the second-stage changing station 11 in response to a control signal from the control unit 15. The second LM guide 13 disposes the die X in the second-stage changing station 11.

As shown in FIG. 4, the second LM guide 13 includes a linear guide mechanism 132 for guiding a die X disposed in the processing station 4 toward the second-stage changing station 11 in a straight line by using a ball screw 131 or the like, and an actuator 133, such as a servomotor, that drives the linear guide mechanism 132. The control unit 15 can transfer, by controlling the second LM guide 13, a die X for which hemming has been completed in the processing station 4 to the second-stage changing station 11 at a high speed.

As described above, when the hemming in the current cycle is completed, the control unit 15 transfers, by controlling the second LM guide 13, the die X, which has been used in the hemming in the current cycle, from the processing station 4 to the second-stage changing station 11 at a high speed and thereby temporarily disposes the die X therein. At the same time, the control unit 15 transfers, by controlling the first LM guide 12, the die X, which has been disposed on standby in the first-stage changing station 10 and will be used in the hemming in the next cycle, to the processing station 4 at a high speed.

As described above, the hemming system 1 according to this embodiment can perform the replacement of the die X in the processing station 4 at a high speed through the above-described course of action during the hemming. That is, it is possible to perform the replacement of the die X in the processing station 4 in a short time (e.g., in a couple of seconds) without requiring a waiting time, and thereby to drastically shorten the cycle time.

The mobile robot 14 is configured, for example, as an articulated arm robot. An end effector capable of holding a die X is provided at the tip (i.e., the end) of the arm. Note that the mobile robot 14 may be formed by an AGV (Automatic Guided Vehicle) or the like. The mobile robot 14 is disposed between the first-stage and second-stage changing stations 10 and 11 and the die storage 9. The mobile robot 14 moves a die X disposed in the second-stage changing station 11 to the die storage 9 and then moves a die X disposed (i.e., stored) in the die storage 9 to the first-stage changing station 10. Note that the mobile robot 14 may move a die X disposed (i.e., stored) in the die storage 9 to the first-stage changing station 10 and then move a die X disposed in the second-stage changing station 11 to the die storage 9.

For example, as shown in FIG. 1, the mobile robot 14 moves along the guide rail 141 in a left/right direction and holds a die X disposed in the second-stage changing station 11 by using the end effector of its arm. Then, the mobile robot 14 disposes the die X held by the end effector of its arm at a predetermined position or at a vacant position in the die storage 9.

Further, the mobile robot 14 moves along the guide rail 141 in the left/right direction and holds a die X disposed (i.e., stored) in the die storage 9 by using the end effector of its arm. Then, the mobile robot 14 disposes the die X held by the end effector of its arm in the second-stage changing station 11.

As described above, it is possible to easily move any of a plurality of types of dies X disposed (i.e., stored) in the die storage 9 to the first-stage changing station 10 by using the mobile robot 14, and to re-dispose the die X disposed in the second-stage changing station 11, the use of which in the processing station 4 has been finished, to the die storage 9.

As shown in FIG. 1, the first to fourth processing robots 5, 6, 7 and 8, and the first-stage and second-stage changing stations 10 and 11 are arranged around the processing station 4 in a circumferential manner. Further, the first and second LM guides 12 and 13 radially extend, between the first to fourth processing robots 5, 6, 7 and 8, from the processing station 4 located at the center of the circumference to the first-stage and second-stage changing stations 10 and 11. Further, the first-stage and second-stage changing stations 10 and 11 are arranged so as to be opposed to each other with the fourth processing robot 8 interposed therebetween.

In this way, the processing station 4, the first to fourth processing robots 5, 6, 7 and 8, and the first-stage and second-stage changing stations 10 and 11 can be arranged close to each other, so that the replacement of the die X in the processing station 4 can be performed at a higher speed.

The control unit 15 controls the carrying-in apparatus 2, the carrying-out apparatus 3, the first to fourth processing robots 5, 6, 7 and 8, the first and second LM guides 12 and 13, and the mobile robot 14. The control unit 15, the carrying-in apparatus 2, the carrying-out apparatus 3, the first to fourth processing robots 5, 6, 7 and 8, the first and second LM guides 12 and 13, and the mobile robot 14 perform wireless communication with each other by using, for example, WiFi (Wireless Fidelity), LAN (Local Area Network), or WAN (Wide Area Network).

The control unit 15 controls the carrying-in of a workpiece to the processing station 4 by the carrying-in apparatus 2 by transmitting a control signal to the carrying-in apparatus 2. The control unit 15 controls the carrying-out of a workpiece from the processing station 4 by the carrying-out apparatus 3 by transmitting a control signal to the carrying-out apparatus 3.

The control unit 15 controls the hemming of a workpiece disposed in the processing station 4 by the first to fourth processing robots 5, 6, 7 and 8 by transmitting a control signal to the first to fourth processing robots 5, 6, 7 and 8. The control unit 15 controls the movement of a die X from the first-stage changing station 10 to the processing station 4 by the first LM guide 12 by transmitting a control signal to the first LM guide 12. The control unit 15 controls the movement of a die X from the processing station 4 to the second-stage changing station 11 by the second LM guide 13 by transmitting a control signal to the second LM guide 13.

The control unit 15 has a hardware configuration of an ordinary computer including, for example, a processor 151 such as a CPU (Central Processing Unit) or a GPU (Graphics Processing Unit), an internal memory 152 such as a RAM (Random Access Memory) or a ROM (Read Only Memory), a storage device 153 such as an HDD (Hard Disk Drive) or an SSD (Solid State Drive), an input/output I/F 154 for connecting peripheral devices such as a display, and a communication I/F 155 for performing communication with external apparatuses.

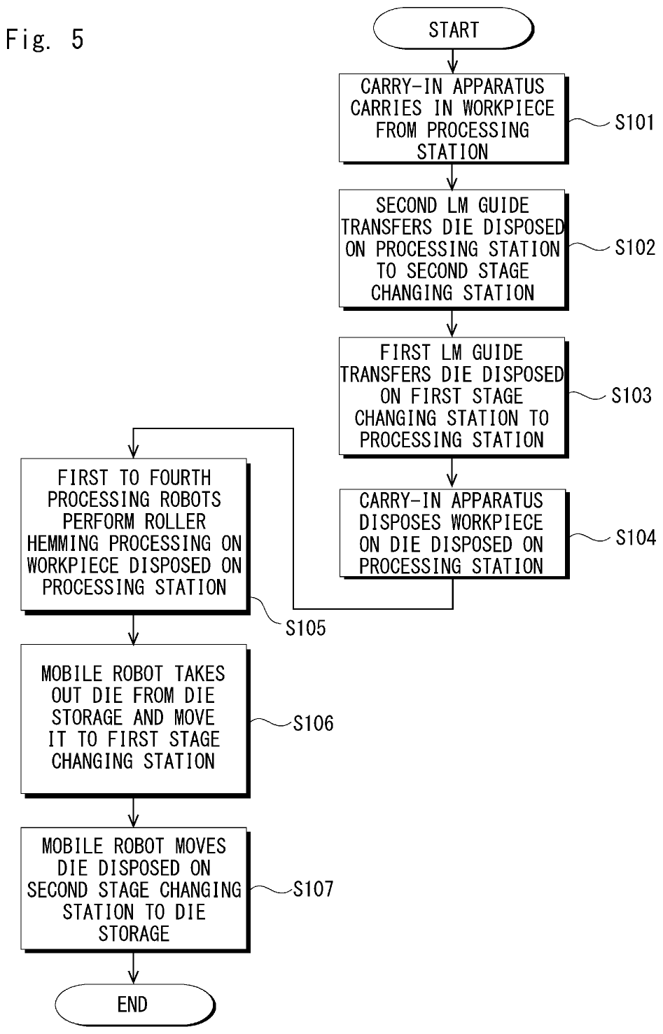

Next, a hemming method performed by the above-described hemming system 1 will be described in detail. FIG. 5 is a flowchart showing a flow of a hemming method according to this embodiment.

A die X that will be used by the first to fourth processing robots 5, 6, 7 and 8 in the next cycle and corresponds to a different type of workpiece is disposed on standby in the first-stage changing station 10.

In response to a control signal from the control unit 15, the carrying-out apparatus 3 takes out and carries out a workpiece, for which the hemming in the current cycle has been completed, from the processing station 4 (Step S101).

The second LM guide 13 transfers the die X disposed in the processing station 4 to the second-stage changing station 11 in response to a control signal from the control unit 15 (Step S102). In synchronization with this transfer, the first LM guide 12 transfers a die X that has been disposed on standby in the first-stage changing station 10 to the processing station 4 in response to a control signal from the control unit 15 and disposes the die X in the processing station 4 (Step S103).

In response to a control signal from the control unit 15, the carrying-in apparatus 2 carries in a workpiece, for which hemming will be performed from now on, to the processing station 4 and disposes the workpiece on the die X (Step S104). In response to a control signal from the control unit 15, the first to fourth processing robots 5, 6, 7 and 8 perform roller hemming on the workpiece disposed on the die X disposed in the processing station 4 (Step S105).

At the same time, in response to a control signal from the control unit 15, the mobile robot 14 takes out a die X for the next cycle from the die storage 9, disposes the die X in the first-stage changing station 10, and leaves the die X on standby until the next cycle (Step S106). Further, in response to a control signal from the control unit 15, the mobile robot 14 moves the die X disposed in the second-stage changing station 11 to the die storage 9 and disposes (i.e., stores) the die X at a predetermined position in the die storage 9 (Step S107).

As described above, the hemming system 1 according to this embodiment includes the processing station 4; the first to fourth processing robots 5, 6, 7 and 8 disposed around the processing station 4 and configured to perform hemming on a workpiece disposed in the processing station 4; the die storage 9 configured to store each of dies X in association with a respective type of workpiece, the dies X being configured to be used when the hemming is performed;
a first-stage changing station 10 in which a die X that will be used by the first to fourth processing robots 5, 6, 7 and 8 when they perform hemming on a next different type of workpiece and hence corresponds to the next different type of workpiece is disposed on standby; the first LM guide 12 for transferring the die X disposed in the first-stage changing station 10 to the processing station 4; the second-stage changing station 11 in which the die X disposed in the processing station 4 is temporarily disposed; the second LM guide 13 for transferring the die X disposed in the processing station 4 to the second-stage changing station 11; and the mobile robot 14 configured to move the die X from the second-stage changing station 11 to the die storage 9 and move the die X from the die storage 9 to the first-stage changing station 10.

The hemming system 1 according to this embodiment transfers and temporarily disposes (i.e., temporarily removes) the die X, which has been used in the hemming in the current cycle, from the processing station 4 to the second-stage changing station 11 at a high speed by controlling the second LM guide 13, and at the same time, transfers a die X, which has been disposed on standby in the first-stage changing station 10 and will be used in hemming in the next cycle, to the processing station 4 at a high speed by controlling the first LM guide 12. In this way, it is possible to perform the replacement of the die X in the processing station 4 in a short time without requiring a waiting time, and thereby to drastically shorten the cycle time.

### Second Embodiment

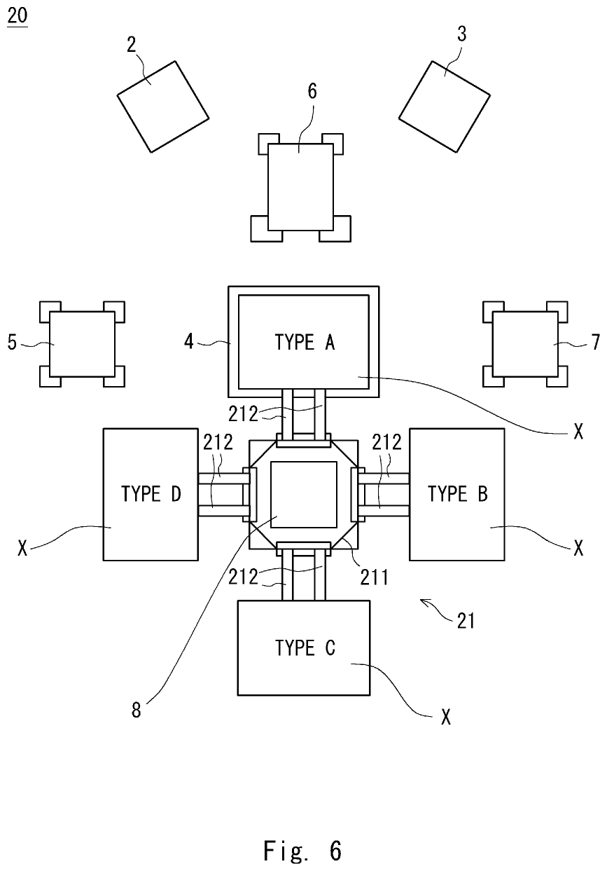

FIG. 6 shows a schematic configuration of a hemming system according to this embodiment. A hemming system 20 according to this embodiment includes a planar rotation mechanism 21 for rotating four types of dies X around a fourth processing robot 8 about an axis perpendicular to the horizontal plane. Note that in the second embodiment, the same reference numerals (or symbols) as those in the above-described first embodiment are assigned to the same components/structures as those in the above-described first embodiment, and detailed descriptions thereof are omitted.

The planar rotation mechanism 21 includes a rotation center part 211 that is disposed in the underside of the fourth processing robot 8 and rotates around the fourth processing robot 8, and four arm parts 212 each of which radially extends from the rotation center part 211. The rotation center part 211 rotates each of the four arm parts 212 about an axis perpendicular to the horizontal plane by using actuators such as servomotors.

Four types of dies X (e.g., Type A, Type B, Type C, and Type D) are provided at the tips (i.e., the ends) of the arm parts 212, respectively. The length of each of the arm part 212 is adjusted so that when the arm part 212 is rotated clockwise or counterclockwise, the tip of the arm part 212 passes through a receiving jig of the processing station 4.

Further, the die X and the receiving jig are configured so that when the tip of the arm part 212 comes to the position of the receiving jig of the processing station 4, the die X disposed at the tip of the arm part 212 can be attached to the receiving jig and vice versa. In this way, the rotation center part 211 enables the die X disposed in the processing station 4 to be flexibly replaced by rotating the arm part 212.

Note that it is also possible to perform hemming using five of more types of dies X in the hemming system 20 according to this embodiment. In this case, the mobile robot 14 or the like may replace the die X disposed at the tip of the arm part 212 with one of the dies X stored in the die storage 9. For example, the mobile robot 14 takes out a desired die X from the die storage 9 and replaces the die X disposed at the tip of the arm part 212 with the desired die X.

According to the hemming system 20 in accordance with this embodiment, the die X disposed in the processing station 4 can be quickly replaced simply by rotating the arm parts 212 of the planar rotation mechanism 21. It is possible to perform the replacement of the die X in the processing station 4 in a short time and thereby to drastically shorten the cycle time.

Although several embodiments according to the present disclosure have been described, these embodiments are shown merely as examples and are not intended to limit the scope of the disclosure. These new embodiments can be implemented in a variety of other forms, and various omissions, replacements, and modifications can be made to the extent that they do not deviate from the scope and spirit of the disclosure. These embodiments and modified examples thereof are included in the scope and spirit of the disclosure and are included in the scope equivalent to the scope of the disclosure specified in the patent claims.

The present disclosure can also be implemented, for example, by having a processor execute a computer program for the processes shown in FIG. 5.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, and RAM (Random Access Memory)).

The program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

Each of the components constituting the hemming system 1 or 20 according to any of the above-described embodiments is, in addition to being able to be implemented by the program, able to be partially or entirely implemented by dedicated hardware such as an ASIC (Application Specific Integrated Circuit) or an FPGA (Field-Programmable Gate Array).

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A hemming system comprising:
a processing station;
a processing robot disposed around the processing station and configured to perform hemming on a workpiece disposed in the processing station;
a die storage configured to store each of dies in association with a respective type of workpiece, the dies being configured to be used when the hemming is performed;
a first-stage changing station in which a die that will be used by the processing robot when the processing robot performs hemming on a next different type of workpiece and hence corresponds to the next different type of workpiece is disposed on standby
first transfer means for transferring the die disposed in the first-stage changing station to the processing station;
a second-stage changing station in which the die disposed in the processing station is temporarily disposed;
second transfer means for transferring the die disposed in the processing station to the second-stage changing station; and
a mobile robot configured to move the die from the second-stage changing station to the die storage and move the die from the die storage to the first-stage changing station. 2. The hemming system according to claim 1, wherein:
the first transfer means is a first LM guide including a linear guide mechanism configured to guide a die disposed in the first-stage changing station toward the processing station in a straight line, and an actuator configured to drive the linear guide mechanism, and
the second transfer means is a second LM guide including a linear guide mechanism configured to guide a die disposed in the processing station toward the second changing station in a straight line, and an actuator configured to drive the linear guide mechanism.

3. The hemming system according to claim 1, further comprising a control unit configured to control the processing robot, the first and second transfer means, and the mobile robot, wherein
when the hemming in a current cycle is completed, the control unit transfers and temporarily disposes a die, which has been used in the hemming in the current cycle, from the processing station to the second-stage changing station by controlling the second transfer means, and at the same time, transfers a die, which has been disposed on standby in the first-stage changing station and will be used in hemming in a next cycle, to the processing station by controlling the first transfer means.

4. The hemming system according to claim 1, wherein:
a plurality of the processing robots, the first-stage changing station, and the second-stage changing station are arranged around the processing station in a circumferential configuration,
the first and second-stage changing stations are arranged so that they are opposed to each other with the processing robot interposed therebetween, and
the first transfer means radially extends, between the processing robots, from the processing station located at the center of the circumference to the first-stage changing station, and
the second transfer means radially extends, between the processing robots, from the processing station located at the center of the circumference to the second-stage changing station.

5. The hemming system according to claim 4, wherein the mobile robot is disposed adjacent to the first and second-stage changing stations, and the die storage in such a manner that the mobile robot is interposed between the first and second-stage changing stations and the die storage.

6. The hemming system according to claim 1, further comprising:
a carrying-in apparatus configured to carry in the workpiece to the processing station;
a carrying-out apparatus configured to carry out the workpiece from the processing station.

7. A hemming method comprising:
performing, by a processing robot disposed around a processing station, hemming on a workpiece disposed in the processing station;
transferring, by first transfer means, a die disposed in a first-stage changing station to the processing station, the first-stage changing station being configured so that a die corresponding to a next type of workpiece is disposed on standby therein, the die being one that the processing robot will use when it performs hemming on the next type of workpiece;
transferring, by second transfer means, the die disposed in the processing station to a second-stage changing station in which the die disposed in the processing station is temporarily disposed;
and
moving, by a mobile robot, the die disposed in the second-stage changing station to a die storage and move a die stored in the die storage to the first-stage changing station.

8. A hemming system comprising:
a processing station;
a processing robot disposed around the processing station and configured to perform hemming on a workpiece disposed in the processing station;
a die storage configured to store each of dies in association with a respective type of workpiece, the dies being configured to be used when the hemming is performed;
a first-stage changing station in which a die that will be used by the processing robot when the processing robot performs hemming on a next different type of workpiece and hence corresponds to the next different type of workpiece is disposed on standby
a first guide configured to transfer the die disposed in the first-stage changing station to the processing station;
a second-stage changing station in which the die disposed in the processing station is temporarily disposed;
a second guide configured to transfer the die disposed in the processing station to the second-stage changing station;
and
a mobile robot configured to move the die from the second-stage changing station to the die storage and move the die from the die storage to the first-stage changing station.
